(19) United States
(12) Patent Application Publication
(10) Pub. No.: US 2010/0232478 A1
(43) Pub. Date: Sep. 16, 2010

(54) Receiver for spread spectrum communication

(75) Inventors: Kenichiro Sanji, Okazaki-city (JP); Akira Takaoka, Okazaki-city (JP); Hiromichi Naitoh, Okazaki-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Nippon Soken, Inc., Nishio-city (JP)

(21) Appl. No.: 12/661,029

(22) Filed: Mar. 9, 2010

(30) Foreign Application Priority Data
Mar. 10, 2009 (JP) 2009-056686

(51) Int. Cl. H04B 1/707

(52) U.S. Cl. 375/150; 375/E01.002

(57) ABSTRACT

A receiver for spread spectrum communication includes a receiver for receiving a wireless signal, a demodulator for demodulating the wireless signal into a spread spectrum signal, a correlation value calculator for calculating a correlation value between the spread spectrum signal and a spreading code having a predetermined number of chips, a synchronization detector for detecting a synchronization point between the spread spectrum signal and the spread signal based on the correlation value, a despreading device for despreading the spread spectrum signal based on the synchronization point, a noise level detector for detecting a noise level of the wireless signal, and a code number setting device for determining the number of chips of the spreading code in such a manner that there is a positive correlation between the noise level and the number of code portions.

### CROSS REFERENCE TO RELATED APPLICATION

This application is based on and incorporates herein by reference Japanese Patent Application No. 2009-56686 filed on Mar. 10, 2009.

### FIELD OF THE INVENTION

The present invention relates to a receiver for spread spectrum communication.

### BACKGROUND OF THE INVENTION

In a spread spectrum method, an original signal is spread by a spreading code at a transmitter side to generate a spread signal, and the spread signal is despread by the spreading code at a receiver side to recover the original signal. It is required to detect a synchronization point between the spread signal and the spreading code in order to despread the spread signal.

In a technique disclosed in U.S. Pat. No. 6,738,412 corresponding to JP-2000-307478A, a transmitter and a receiver communicate with each other to determine a chip rate of a spreading code used for spreading and dispreading so that the chip rate can be matched between the transmitter and the receiver. In such an approach, the number of computations needed to detect a synchronization point is reduced so that power consumption can be reduced.

However, the technique disclosed in U.S. Pat. No. 6,738,412 needs a computation process and a communication process to match the chip rate between the transmitter and the receiver. These processes can increase power consumption.

### SUMMARY OF THE INVENTION

In view of the above, it is an object of the present invention to provide a technique for reducing power consumption in spread spectrum communication without changing a chip rate of a spreading code.

According to an aspect of a present invention, a receiver for spread spectrum communication includes a receiving device configured to receive a wireless signal, a demodulator configured to demodulate the wireless signal into a spread spectrum signal, and a correlation value calculator configured to calculate a correlation value between the spread spectrum signal and a spreading code having a first number of code portions. The spreading code has a second number of code portions in one period thereof. The second number of code portions corresponds to one bit of the spread spectrum signal. The receiver further includes a synchronization detector configured to detect a synchronization point between the spread spectrum signal and the spread signal based on the correlation value, a despreading device configured to despread the spread spectrum signal based on the synchronization point, a noise level detector configured to detect a noise level of the wireless signal, and a code number setting device configured to determine the first number of code portions in such a manner that there is a positive correlation between the noise level and the first number of code portions.

According to another aspect of the present invention, a receiver for spread spectrum communication includes a receiving device configured to receive a wireless signal, a demodulator configured to demodulate the wireless signal into a spread spectrum signal, and a correlation value calculator configured to calculate a correlation value between the spread spectrum signal and a spreading code having a first number of code portions. The spreading code has a second number of code portions in one period thereof. The second number of code portions corresponds to one bit of the spread spectrum signal. The receiver further includes a synchronization detector configured to detect a synchronization point between the spread spectrum signal and the spread signal based on the correlation value, a despreading device configured to despread the spread spectrum signal based on the synchronization point, a synchronization determination device configured to determine whether the synchronization detector succeeds in detecting the synchronization point or fails to detect the synchronization point, and a code number setting device configured to increase the first number of code portions upon determination by the synchronization determination device that the synchronization detector fails to detect the synchronization point.

### BRIEF DESCRIPTION OF THE DRAWINGS

The above and other objectives, features and advantages of the present invention will become more apparent from the following detailed description made with check to the accompanying drawings. In the drawings:

FIG. 1 is a block diagram of a smart keyless entry system according to an embodiment of the present invention;

FIG. 2 is a diagram illustrating a method of calculating a correlation value;

FIG. 3 is a diagram illustrating a correlation characteristic;

FIG. 4 is a diagram illustrating a relationship between a noise level and an target chip number;

FIG. 5A is a diagram illustrating a relationship between a length of a spreading code, a length of a received data, and the correlation characteristic, and FIG. 5B is a diagram illustrating a relationship between a noise resistance and the number of samples of the received data taken in a correlation calculation process; and

FIG. 6A is a diagram illustrating a noise detection according to the embodiment, FIG. 6B is a diagram illustrating a synchronization detection according to the embodiment, and FIG. 6C is a diagram illustrating a synchronization detection according to a modification of the embodiment.

### DETAILED DESCRIPTION OF THE PREFERRED EMBODIMENT

A smart keyless entry system 1 according to an embodiment of the present invention is described below with reference to the drawings.

The smart keyless entry system 1 has both a so-called smart entry function and a so-called keyless entry function. For example, the smart entry function can unlock a door of a vehicle, when a specific mobile unit carried by an authorized user of the vehicle enters a predetermined wireless communication area around the vehicle. For example, the keyless entry function can lock and unlock the door of the vehicle in response to operation of a button on the mobile unit.

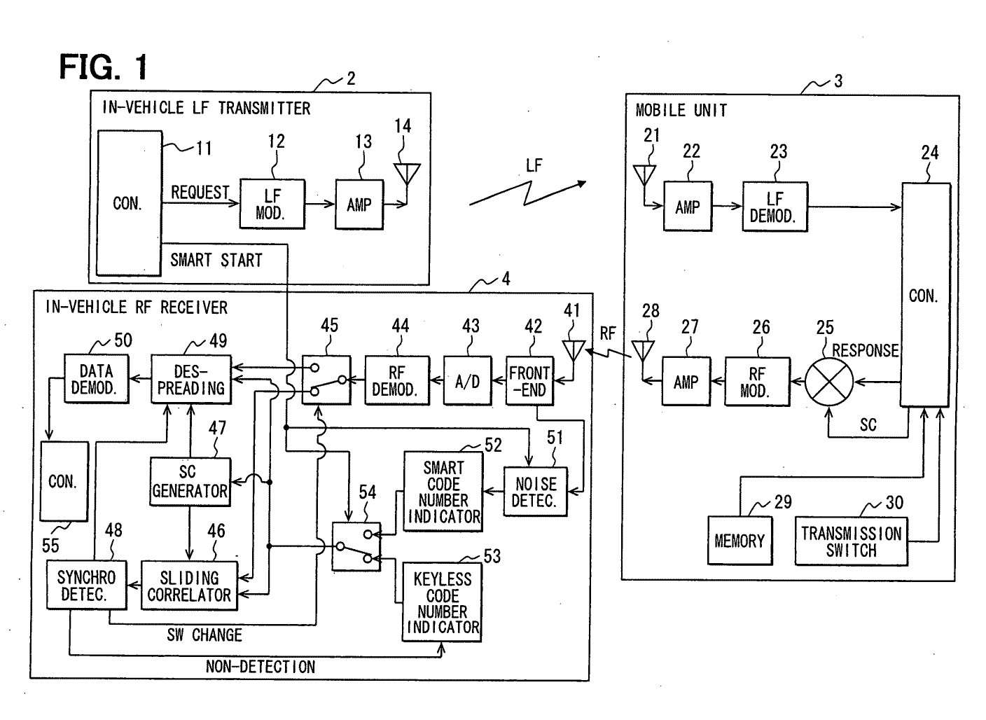

FIG. 1 is a block diagram of the smart keyless entry system 1. The smart keyless entry system 1 includes an in-vehicle low frequency (LF) transmitter 2, a mobile unit 3, and an in-vehicle radio frequency (RF) receiver 4.

The in-vehicle LF transmitter 2 is configured to transmit a LF wireless signal of a low frequency band to the mobile unit 3. The mobile unit 3 is configured to transmit a RF wireless signal of a radio frequency band to the in-vehicle RF receiver 4 by a spread spectrum method.

The in-vehicle LF transmitter 2 includes a controller 11, a LF modulator 12, a filter-amplifier 13, and a LF transmitting antenna 14.

The controller 11 outputs data containing a request signal. Further, the controller 11 outputs a smart operation start signal to the in-vehicle RF receiver 4 immediately after outputting the data. The smart operation start signal indicates that the request signal was outputted.

The LF modulator 12 modulates the data outputted from the controller 11 to generate a signal of a LF band. The signal generated by the LF modulator 12 is filtered and amplified through the filter-amplifier 13. The LF transmitting antenna 14 transmits the filtered/amplified signal by wireless. The signal transmitted from the LF transmitting antenna 14 is hereinafter called a “LF wireless signal”.

The mobile unit 3 includes a LF receiving antenna 21, a filter-amplifier 22, a LF demodulator 23, a controller 24, an exclusive OR (XOR) operation circuit 25, a RF modulator 26, a filter-amplifier 27, a RF transmitting antenna 28, a memory 29, and a transmission switch 30.

The memory 29 stores an identification (ID) code assigned to the mobile unit 3. Further, the memory 29 stores a spreading code for spread spectrum communication. The transmission switch 30 is used to transmit the ID code.

The LF receiving antenna 21 receives the LF wireless signal transmitted from the in-vehicle LF transmitter 2. The LF wireless signal received by the LF receiving antenna 21 is filtered and amplified through the filter-amplifier 22. The LF demodulator 23 demodulates the filtered/amplified LF wireless signal into the data containing the request signal.

Upon reception of the request signal from the LF demodulator 23, the controller 24 outputs both a response signal containing the ID code stored in the memory 29 and the spreading code stored in the memory 29. Further, upon operation of the transmission switch 30, the controller 24 outputs both the response signal and the spreading code.

The XOR operation circuit 25 performs a XOR operation between the response signal and the spreading code outputted from the controller 24 to spread the response signal with the spreading code, thereby generating a spread-spectrum signal. The RF modulator 26 modulates the spread-spectrum signal to generate a signal of a RF band. The signal generated by the RF modulator 26 is filtered and amplified through the filter-amplifier 27. The RF transmitting antenna 28 transmits the filtered/amplified signal by wireless. The signal transmitted from the RF transmitting antenna 28 is hereinafter called a “RF wireless signal”.

The in-vehicle RF receiver 4 includes a RF receiving antenna 41, a front-end 42, an analog-to-digital (A/D) converter 43, a RF demodulator 44, a switch 45, a sliding correlator 46, a spreading code generator 47, a synchronization detector 48, a despreading device 49, a data demodulator 50, a noise detector 51, a smart spreading code number indicator 52, a keyless spreading code number indicator 53, a switch 54, and a controller 55.

The RF receiving antenna 41 receives the RF wireless signal transmitted from the mobile unit 3. The front-end 42 filters and amplifies the RF wireless signal received by the RF receiving antenna 41. Further, the front-end 42 converts the RF wireless signal into a signal of a lower frequency. The A/D converter 43 converts an output of the front-end 42 into a digital signal. The RF demodulator 44 demodulates the digital signal.

The switch 45 receives the digital signal from the RF demodulator 44. Further, the switch 45 receives a switch change signal from the synchronization detector 48. In accordance with the switch change signal, the switch 45 switches to one of the sliding correlator 46 side and the despreading device 49 side so that the digital signal can be forwarded to the one of the sliding correlator 46 and the despreading device 49 through the switch 45.

The digital data outputted from the RF demodulator 44 through the switch 45 is hereinafter called a “received data”. The sliding correlator 46 receives the received data from the switch 45, a spreading code from the spreading code generator 47, and a spreading code number signal from the switch 54. The sliding correlator 46 calculates a correlation characteristic between the received data and the spreading code.

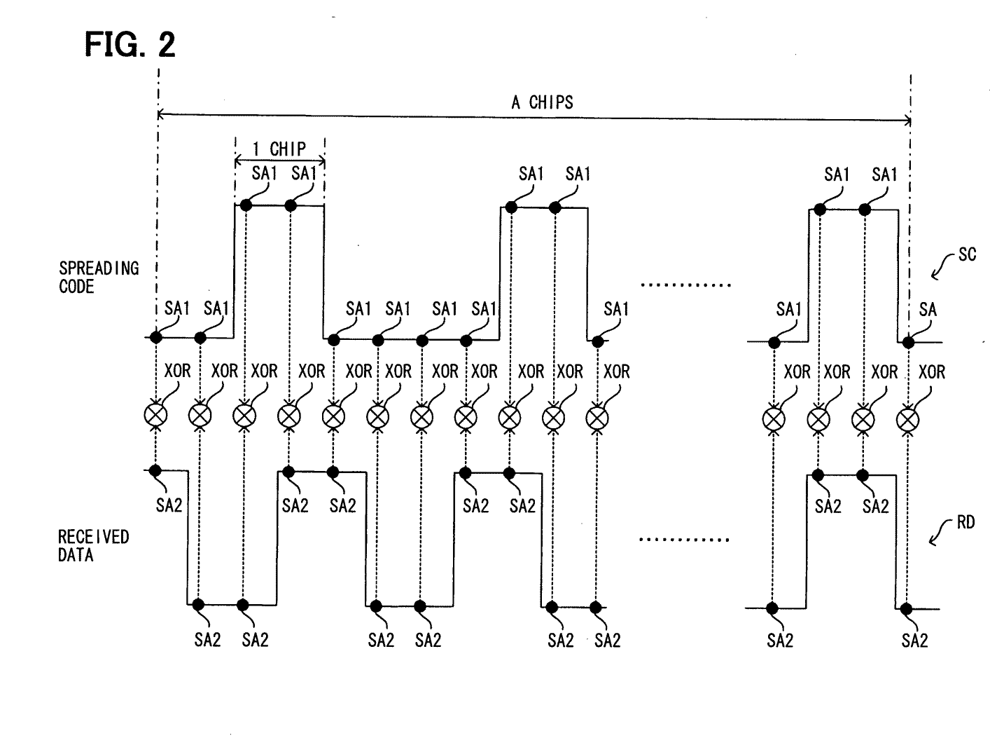

Specifically, as shown in FIG. 2, the sliding correlator 46 performs an XOR operation between a sample SA1 of a spreading code SC having chips the number of which is indicated by the spreading code number signal and a sample SA2 of a received data RD corresponding to the sample SA1 for every sample SA1 of the spreading code SC. Then, the sliding correlator 46 outputs the sum of XOR operation values.

For example, assuming that the number of chips in the spreading code SC is defined as “A” [chips] and that the number of samples of the received data RD taken per one chip of the spreading code is defined as “B” [samples/chip], the number of XOR operations becomes “A×B”. The sliding correlator 46 outputs the sum of “A×B” XOR operation values. The sum of “A×B” XOR operation values is hereinafter called a “correlation value”. A process of calculating the correlation value is hereinafter called “a correlation calculation process”.

After outputting one correlation value, the sliding correlator 46 repeats the correlation calculation process by shifting the received data RD by one sample. This reparation is continued for one period of the spreading code.) For example, assuming that the number of samples of the received data RD taken per one chip of the spreading code is defined as “B” The spreading code generator 47 receives the spreading code number signal from one of the smart spreading code number indicator 52 and the keyless spreading code number indicator 53 through the switch 54. The spreading code number signal indicates the number of chips of the spreading code. The number of chips indicated by the spreading code number signal is hereinafter called a “target chip number”. The spreading code generator 47 outputs to each of the sliding correlator 46 and the despreading device 49 the spreading code having the target chip number of chips.

It is noted that the spreading code generator 47 stores the spreading code having chips the number of which corresponds to one period of the spreading code. For example, assuming that the number of chips in one period of the spreading code is defined as“C” [chips] and that the target chip number is “0.3×C”, the spreading code generator 47 outputs the spreading code having “0.3×C” chips by extracting the spreading code having “0.3×C” from the spreading code having “C” chips. For another example, assuming that the target chip number is “4×C”, the spreading code generator 47 continuously outputs the spreading code having “C” chips four times, thereby outputting a continuous spreading code having “4×C” chips.

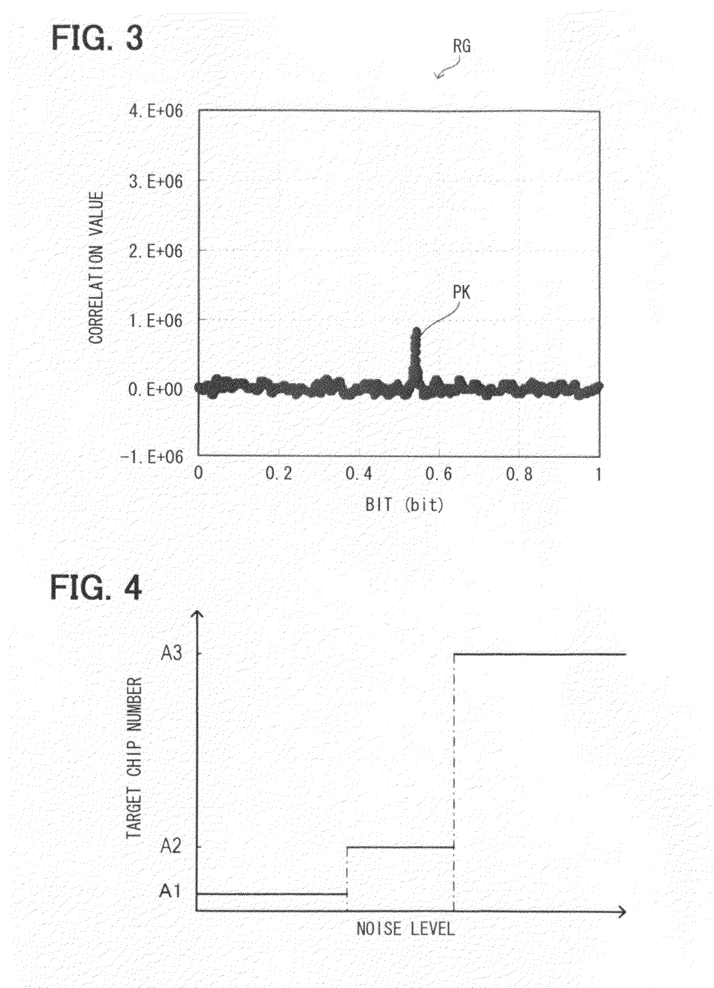

The synchronization detector 48 receives the correlation values for one period of the spreading code from the sliding correlator 46 and detects a synchronization point based on the correlation values. Specifically, as shown in FIG. 3, a correlation characteristic RG is measured by arranging the correlation values in received order, and a peak PK in the correlation characteristic RG is detected. The synchronization point is defined as a point at which the correlation value corresponding to the peak PK is calculated.

If the synchronization detector 48 can detect the synchronization point, the synchronization detector 48 outputs to the despreading device 49 a synchronization point signal indicating the detected synchronization point. Further, the synchronization detector 48 outputs the switch change signal to the switch 45. Upon reception of the switch change signal, the switch 45 switches from the sliding correlator 46 side to the despreading device 49 side so that the digital data received from the RF demodulator 44 can be forwarded to the despreading device 49 through the switch 45.

In contrast, if the synchronization detector 48 cannot detect the synchronization point, the synchronization detector 48 outputs to the keyless spreading code number indicator 53 a synchronization failed signal indicating that the synchronization detector 48 fails to detect the synchronization point.

The despreading device 49 receives the digital signal (i.e., received data) from the switch 45, the spreading code from the spreading code generator 47, the synchronization point signal from the synchronization detector 48, and the spreading code number signal from the switch 54. While synchronizing with the synchronization point signal, the despreading device 49 despreads the received data corresponding to the target chip number by using the spreading code outputted from the spreading code generator 47.

The data demodulator 50 demodulates the despread data and outputs the demodulated data to the controller 55.

The noise detector 51 receives the smart operation start signal from the in-vehicle LF transmitter 2. Upon reception of the smart operation start signal, the noise detector 51 detects a noise level of an output signal of the front-end 42 continuously for a predetermined noise detection time period (e.g., 10 ms). Then, the noise detector 51 outputs the detected noise level to the smart spreading code number indicator 52. It is noted that the noise detection time period is determined by taking into consideration the time period from when the in-vehicle LF transmitter 2 transmits the request signal to when the in-vehicle RF receiver 4 receives the response signal.

The smart spreading code number indicator 52 receives the noise level from the noise detector 51. The smart spreading code number indicator 52 determines the target chip number according to the noise level. Then, the smart spreading code number indicator 52 outputs the spreading code number signal, indicating the determined target chip number, to each of the sliding correlator 46, the spreading code generator 47, and the despreading device 49. It is noted that the smart spreading code number indicator 52 determines the target chip number in such a manner that the target chip number is increased with an increase in the noise level. In the embodiment, as shown in FIG. 4, the target chip number has one of three values A1, A2, A3 (A1<A2<A3) according to the noise level. In other words, the target chip number can change in three stages according to the noise level. In the embodiment, assuming that the number of chips in one period of the spreading code is defined as “C”, the target chip number A1 is “0.3×C”, the target chip number A2 is “1×C”, and the target chip number A3 is “4×C”.

The keyless spreading code number indicator 53 receives the synchronization failed signal from the synchronization detector 48. The keyless spreading code number indicator 53 determines the target chip number in such a manner that the target chip number is increased each time when the synchronization failed signal is received. Then, the keyless spreading code number indicator 53 outputs the spreading code number signal, indicating the determined target chip number, to each of the sliding correlator 46, the spreading code generator 47, and the despreading device 49. In the embodiment, the target chip number is increased from the value A1 to the value A3 by way of the value A2 each time when the synchronization failed signal is received.

The switch 54 receives the spreading code number signal from the smart spreading code number indicator 52, the spreading code number signal from the keyless spreading code number indicator 53, and the smart operation start signal from the in-vehicle LF transmitter 2. In accordance with the smart operation start signal, the switch 54 switches to one of the smart spreading code number indicator 52 and the keyless spreading code number indicator 53 so that the spreading code number signal received from the one of the smart spreading code number indicator 52 and the keyless spreading code number indicator 53 can be forwarded to the spreading code generator 47 through the switch 54. Specifically, upon reception of the smart operation start signal, the switch 54 switches from the keyless spreading code number indicator 53 side to the smart spreading code number indicator 52 side so that the spreading code number signal received from the smart spreading code number indicator 52 can be forwarded to the spreading code generator 47 through the switch 54.

The controller 55 receives the demodulated data from the data demodulator 50 and extracts the ID code from the demodulated data. Then, the controller 55 performs authentication of the extracted ID code. If the authentication results in success, the controller 55 performs operations necessary to achieve the smart entry function and the keyless entry function. For example, the controller 55 can perform an operation to control a door lock/unlock and an operation to control a start of an engine.

The smart keyless entry system 1 works as follows, when the smart entry function is used.

Firstly, in the in-vehicle LF transmitter 2, the controller 11 outputs the data containing the request signal. Then, the data is modulated by the LF modulator 12, passed through the filter-amplifier 13, and inputted to the LF transmitting antenna 14. Thus, the LF wireless signal is transmitted from the LF transmitting antenna 14.

In the mobile unit 3, the LF receiving antenna 21 receives the LF wireless signal transmitted from the in-vehicle LF transmitter 2. The received LF wireless signal is passed through the filter-amplifier 22 and demodulated by the LF demodulator 23. Thus, the data containing the request signal is inputted to the controller 24.

Upon reception of the request signal, the controller 24 outputs both the response signal and the spreading code. The response signal and the spreading code are inputted to the XOR operation circuit 25. The output of the XOR operation circuit 25 is modulated by the RF modulator 26, passed through the filter-amplifier 27, and inputted to the RF transmitting antenna 28. Thus, the RF wireless signal is transmitted from the RF transmitting antenna 28.

In the in-vehicle RF receiver 4, the RF receiving antenna 41 receives the RF wireless signal. The RF wireless signal received by the RF receiving antenna 41 is passed through the front-end 42, converted into the digital signal by the A/D converter 43, and demodulated by the RF demodulator 44. The output of the RF demodulator 44 is inputted to one of the sliding correlator 46 and the despreading device 49 through the switch 45. As of the time prior to synchronization detection, the output of the RF demodulator 44 is inputted to the sliding correlator 46 through the switch 45.

In response to the smart operation start signal, the noise detector 51 detects the noise level of the output signal of the front-end 42 continuously for the noise detection time period (e.g., 10 ms) from when the in-vehicle LF transmitter 2 outputs the request signal.

Then, the smart spreading code number indicator 52 outputs the spreading code number signal indicating the target chip number that is determined according to the noise level.

Further, when the in-vehicle LF transmitter 2 outputs the request signal, the switch 54 switches to the smart spreading code number indicator 52 side in response to the smart operation start signal. Thus, the spreading code number signal received from the smart spreading code number indicator 52 is inputted to the spreading code generator 47.

The spreading code generator 47 outputs to each of the sliding correlator 46 and the despreading device 49 the spreading code having the target chip number of chips indicated by the spreading code number signal.

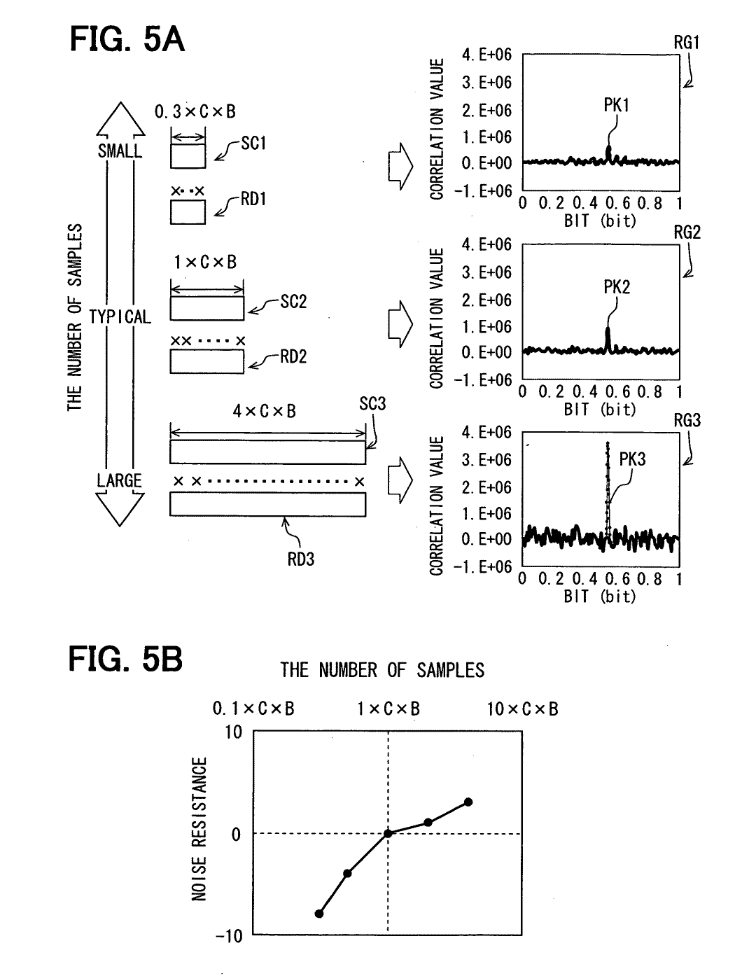

The sliding correlator 46 receives the received data and the spreading code outputted from the spreading code generator 47 and performs the correlation calculation process to calculate the correlation characteristic between the received data and the, spreading code. In this case, assuming that the target chip number of the spreading code is defined as A FIG. 5A is a diagram illustrating lengths of spreading codes SC1-SC3, lengths of received data RD1-RD3, and correlation characteristics RG1-RG3 for the target chip numbers A1-A3, respectively.

As can be seen by referring to the spreading code SC1 and the received data RD1 in FIG. 5A, when the target chip number is A1 (=“0.3×C”), the number of samples of the received data RD1 taken per one correlation calculation process is “0.3×C×B”. As can be seen by referring to the spreading code SC2 and the received data RD2 in FIG. 5A, when the target chip number is A2 (=“1×C”), the number of samples of the received data RD2 taken per one correlation calculation process is “1×C×B”. As can be seen by referring to the spreading code SC3 and the received data RD3 in FIG. 5A, when the target chip number is A3 (=“4×C”), the number of samples of the received data RD3 taken per one correlation calculation process is “4×C×B”. In this way, as the target chip number of the spreading code is increased, the number of samples of the received data taken per one correlation calculation process is increased.

As shown in FIG. 5A, when the target chip number is A1, the correlation characteristic RG1 has a peak PK1. When the target chip number is A2, the correlation characteristic RG2 has a peak PK2 that is greater than the peak PK1. When the target chip number is A3, the correlation characteristic RG3 has a peak PK3 that is greater than the peak PK2. Therefore, as the number of chips used in the correlation calculation process is increased, the peak can be effectively detected without being affected by noise. In other words, as the number of samples of the received data taken in the correlation calculation process is increased, a resistance to noise for synchronization detection is improved as shown in FIG. 5B.

The synchronization detector 48 receives the correlation values for one period of the spreading code and detects the synchronization point based on the correlation values (i.e., correlation characteristic).

Then, when the synchronization detector 48 detects the synchronization point, the switch 45 switches to the despreading device 49 side so that the output of the RF demodulator 44 can be inputted to the despreading device 49 through the switch 45.

The despreading device 49 despreads the output of the RF demodulator 44 by using the spreading code outputted from the spreading code generator 47. Then, the despreading device 49 outputs the despread data.

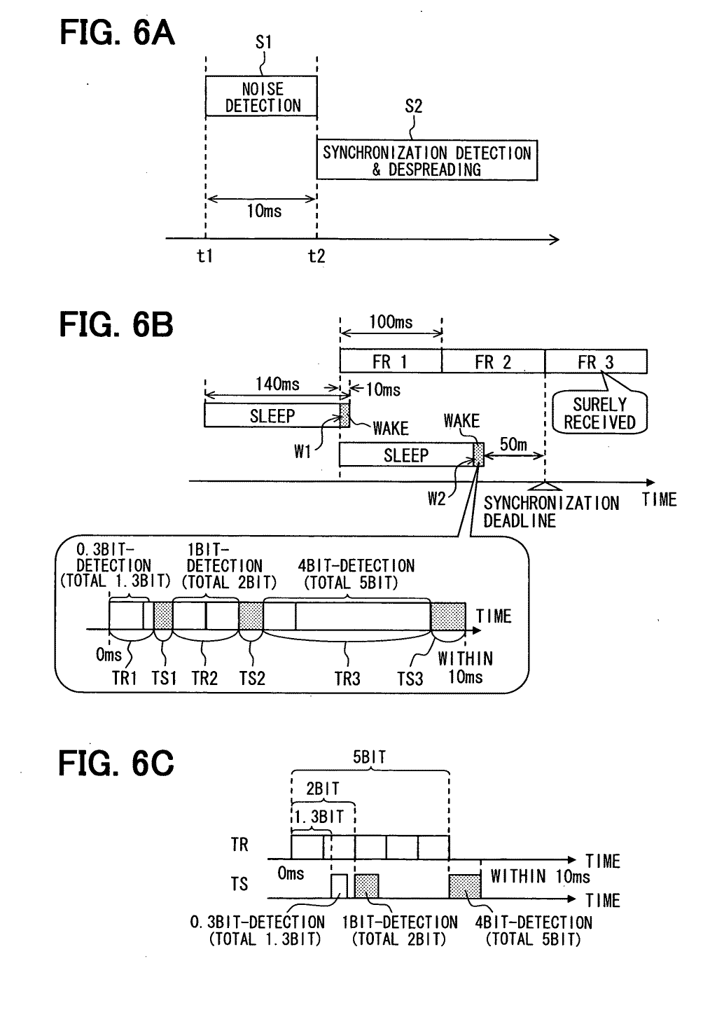

That is, as can be seen by referring to a process S1 in FIG. 6A, the noise level is detected continuously for the noise detection time period (e.g., 10 ms) from a time t1 at which the in-vehicle LF transmitter 2 outputs the request signal. Then, as can be seen by referring to a process S2 in FIG. 6A, synchronization detection and despreading are performed from a time t2 at which the noise detection time period is finished.

The data outputted from the despreading device 49 is demodulated by the data demodulator 50 and sent to the controller 55. The controller 55 performs operations necessary to achieve the smart entry function based on the data outputted from the data demodulator 50.

The smart keyless entry system 1 works as follows, when the keyless entry function is used.

When the transmission switch 30 of the mobile unit 3 is operated, the mobile unit 3 outputs both the response signal and the spreading code. The response signal and the spreading code are inputted to the XOR operation circuit 25. The output of the XOR operation circuit 25 is modulated by the RF modulator 26, passed through the filter-amplifier 27, and inputted to the RF transmitting antenna 28. Thus, the RF wireless signal is transmitted from the RF transmitting antenna 28.

In the in-vehicle RF receiver 4, the RF receiving antenna 41 receives the RF wireless signal. The RF wireless signal received by the RF receiving antenna 41 is passed through the front-end 42, converted into the digital signal by the A/D converter 43, and demodulated by the RF demodulator 44. The output of the RF demodulator 44 is inputted to one of the sliding correlator 46 and the despreading device 49 through the switch 45. As of the time prior to synchronization detection, the output of the RF demodulator 44 is inputted to the sliding correlator 46 through the switch 45.

Firstly, the keyless spreading code number indicator 53 outputs to the spreading code generator 47 the spreading code number signal indicating the minimum target chip number A1. It is noted that when the keyless entry function is used, the smart operation start signal is not inputted to the switch 54. Therefore, the switch 54 remains switched to the keyless spreading code number indicator 53 side so that the spreading code number signal outputted from the keyless spreading code number indicator 53 can be inputted to the spreading code generator 47.

The spreading code generator 47 outputs to each of the sliding correlator 46 and the despreading device 49 the spreading code having the minimum target chip number A1 of chips indicated by the spreading code number signal.

As with the case where the smart entry function is used, the sliding correlator 46 receives the received data and the spreading code outputted from the spreading code generator 47 and performs the correlation calculation process for one period of the spreading code. The synchronization detector 48 receives the correlation values from the sliding correlator 46 and detects the synchronization point based on the correlation values.

If the synchronization detector 48 detects the synchronization point, the switch 45 switches from the sliding correlator 46 side to the despreading device 49 side so that the output of the RF demodulator 44 can be inputted to the despreading device 49 through the switch 45. Therefore, the despreading device 49, the data demodulator 50, and the controller 55 work in the same manner as the case where the smart entry function is used.

In contrast, if the synchronization detector 48 fails to detect the synchronization point, the synchronization detector 48 outputs the synchronization failed signal to the keyless spreading code number indicator 53. In response to the synchronization failed signal, the keyless spreading code number indicator 53 outputs the spreading code number signal indicating the target chip number greater than the present target chip number by one stage. For example, when the present target chip number is A1, the keyless spreading code number indicator 53 outputs the spreading code number signal indicating the target chip number A2. For another example, when the present target chip number is A2, the keyless spreading code number indicator 53 outputs the spreading code number signal indicating the target chip number A3. Thus, the sliding correlator 46 performs the correlation calculation process for one period of the spreading code by using the spreading code having an increased target chip number of ‘chips.

It is noted that when the keyless entry function is used, the in-vehicle RF receiver 4 varies between a “Wake” mode and a “Sleep” mode to reduce a dark (i.e., wasted) current in the in-vehicle RF receiver 4. Therefore, in a communication format of the RF wireless signal transmitted from the mobile unit 3, the same data is repeated several times so that the in-vehicle RF receiver 4 can surely receive the data.

As shown in FIG. 6B, when the in-vehicle RF receiver 4 varies from the “Sleep” mode to the “Wake” mode, the in-vehicle RF receiver 4 performs synchronization detection by sequentially changing the target chip number from A1 to A3 by way of A2 during the “Wake” mode.

FIG. 6B depicts an example where the in-vehicle RF receiver 4 alternates between the “Sleep” mode of 140 ms and the “Wake” mode of 10 ms, and the mobile unit 3 transmits the RF wireless signal, in which a data frame having a length of 100 ms is repeated three times to form the RF wires signal. In other words, in the RF wireless signal transmitted from the mobile unit 3, three frames FR1-FR3 having the same data and the same length of 100 ms are sequentially arranged to form the RF wireless signal.

When the in-vehicle RF receiver 4 changes to the “Wake” mode (refer to W1, W2 in FIG.6B) during reception of the frame FR1 and during reception of the frame FR2, the synchronization detection is sequentially performed with the target chip number A1 (=0.3 bits), the target chip number A2 (=1 bits), and the target chip number A3 (=4 bits) within a period of 10 ms for which the “Wake mode” is continued. The synchronization detection is finished, when synchronization is detected. In such an approach, the last frame FR3 can be surely received.

As shown in FIG. 6B, in the case of the synchronization detection with the target chip number A1 (=0.3 bits), a time TR1 is necessary to receive 1.3 bits of the RF wireless signal, and a time TS1 is necessary to calculate synchronization. In the case of the synchronization detection with the target chip number A2 (=1 bits), a time TR2 is necessary to receive 2 bits of the RF wireless signal, and a time TS2 is necessary to calculate synchronization. In the case of the synchronization detection with the target chip number A3 (=4 bits), a time TR3 is necessary to receive 5 bits of the RF wireless signal, and a time TS3 is necessary to calculate synchronization. Alternatively, as shown in FIG. 6C, 5 bits of the RF wireless signal can be received while being stored in a memory or a register. Specifically, in the example of FIG. 6C, the synchronization detection with the target chip number A1 is performed when 1.3 bits of the 5 bit-RF wireless signal is received. If the synchronization is not detected, the synchronization detection with the target chip number A2 is performed when 2 bits of the 5 bit-RF wireless signal is received. If the synchronization is not detected, the synchronization detection with the target chip number A3 is performed when 5 bits of the 5 bit-RF wireless signal is received. In such an approach, the time TR1 and the time TR2 can be reduced.

As described above, in the smart keyless entry system 1 according to the embodiment, the RF receiving antenna 41 receives the RF wireless signal, and the RF demodulator 44 demodulates the RF wireless signal into the spread spectrum signal. The sliding correlator 46 calculates the correlation characteristic between the spread spectrum signal and the spreading code having the target chip number of chips. The synchronization detector 48 detects the synchronization point between the spread spectrum signal and the spreading code based on the correlation characteristic calculated by the sliding correlator 46. Then, the despreading device 49 despreads the spread spectrum signal based on the synchronization point detected by the synchronization detector 48.

The noise detector 51 detects the noise level of the RF wireless signal received by the RF receiving antenna 41. The smart spreading code number indicator 52 determines the target chip number based the detected noise level in such a manner that there is a positive correlation between the noise level and the target chip number.

In such an approach, as the noise level of the received RF wireless signal becomes smaller, the number of chips of the spreading code used to calculate the correlation characteristic is reduced. In summary, as the noise level becomes smaller, the number of operations (i.e., computations) needed to calculate the correlation characteristic is reduced. A reason for this is as follows. Generally, one period of the spreading code and one period of the spread spectrum signal are necessary to calculate each of the correlation values constructing one period of the correlation characteristic. However, when the noise level is small, the noise resistance can be reduced. Accordingly, even when the number of chips of the spreading code used to calculate the correlation characteristic is reduced, the synchronization can be detected.

In a conventional method, a correlation characteristic is calculated by fixing the number of chips of the spreading code to a typical value regardless of the noise revel. Generally, the noise level of the received RF wireless signal is relatively small. Therefore, according to the embodiment, the correlation characteristic can be frequently calculated by reducing the number of chips of the spreading code below the typical value. As a result, the total number of operations needed to calculate the correlation characteristic can be reduced compared to the conventional method. Accordingly, power consumption in the in-vehicle RF receiver 4 can be reduced.

As the target chip number becomes larger, the correlation value (i.e., peak) at the synchronization point in the correlation characteristic becomes larger. In summary, as the target chip number becomes larger, it is less likely that the synchronization detection is affected by noise contained in the RF wireless signal. In other words, if the noise level of the RF wireless signal is small, the synchronization detection can be achieved even when the target chip number is small. In the in-vehicle RF receiver 4, the target chip number is determined in such a manner that there is a positive correlation between the noise level and the target chip number. This approach can prevent the target chip number from being too small to detect the synchronization point.

In this way, according to the in-vehicle RF receiver 4, power consumption in spread spectrum communication is reduced by changing the target chip number of the spreading code used to calculate the correlation characteristic. That is, a chip rate of the spreading code is unchanged.

The noise detector 51 detects the noise level continuously for the noise detection time period from when the in-vehicle LF transmitter 2 transmits the request signal to when the RF receiving antenna 41 receives the RF wireless signal. In such an approach, the noise level can be detected without a process for extracting noise from the signal received by the in-vehicle RF receiver 4.

The synchronization detector 48 determines whether the synchronization point detection succeeds or fails. If the synchronization detector 48 determines that the synchronization point detection fails, the keyless spreading code number indicator 53 increases the target chip number more than the present value.

In summary, the correlation characteristic is calculated by using the smallest target chip value (e.g., A1) firstly. Then, if the synchronization point detection fails, the target chip value is increased to the second smallest value (e.g., A2). In this way, the correlation characteristic is calculated by increasing the target chip value in ascending order, for example, from A1 to A3, and the correlation characteristic calculation is finished at the time when the synchronization point is detected.

Therefore, the total number of operations needed to calculate the correlation characteristic can be reduced compared to the conventional method where the correlation characteristic is calculated by fixing the number of chips of the spreading code to a typical value regardless of the noise revel. Accordingly, power consumption in the in-vehicle RF receiver 4 can be reduced.

The in-vehicle RF receiver 4 can serve as a spread spectrum communication receiver, the RF receiving antenna 41 can serve as a receiving device, the RF demodulator 44 can serve as a demodulator, the sliding correlator 46 can serve as a correlation value calculator, the synchronization detector 48 can serve as a synchronization detector, the despreading device 49 can serve as a despreading device, the noise detector 51 can serve as a noise level detector, the smart spreading code number indicator 52 can serve as a spreading code number setting device, the mobile unit 3 can serve as a transmitter, the synchronization detector 48 can serve as a synchronization determination device, and the keyless spreading code number indicator 53 can serve as a spreading code number setting device.

The chips of the spreading code correspond to code portions of a spreading code. The target chip number of chips corresponds to a first number of chip portions. The number of chips in one period corresponds to a second number of code portions.

(Modification)

The embodiment described above can be modified in various ways, for example, as follows.

In the embodiment, the correlation characteristic is calculated by using the sliding correlator 46. Alternatively, a matched filter can be used instead of the sliding correlator 46.

In the embodiment, the target chip number changes step by step according to the noise level. Alternatively, the target chip number can change continuously according to the noise level.

In the embodiment, the present invention is applied to a smart keyless entry system. Alternatively, the present invention can be applied to a smart entry system and a keyless entry system individually.

In the embodiment, the request signal is carried by a wireless signal of a LF band. Alternatively, the request signal can be carried by a wireless signal of a frequency band other than the LF band.

In the embodiment, the RF demodulator 44 is located in front of the A/D converter 43. Alternatively, the RF demodulator 44 can be located in back of the A/D converter 43.

Such changes and modifications are to be understood as being within the scope of the present invention as defined by the appended claims.

What is claimed is:

1. A receiver for spread spectrum communication comprising:
a receiving device configured to receive a wireless signal;
a demodulator configured to demodulate the wireless signal into a spread spectrum signal;
a correlation value calculator configured to calculate a correlation value between the spread spectrum signal and a spreading code having a first number of code portions, the spreading code having a second number of code portions in one period thereof, the second number of code portions corresponding to one bit of the spread spectrum signal;
a synchronization detector configured to detect a synchronization point between the spread spectrum signal and the spread signal having the first number of code portions based on the correlation value;
a despreading device configured to despread the spread spectrum signal based on the synchronization point;
a noise level detector configured to detect a noise level of the wireless signal; and
a code number setting device configured to determine the first number of code portions in such a manner that there is a positive correlation between the noise level and the first number of code portions.

2. The receiver according to claim 1, further comprising:
a transmitting device configured to transmit a request signal requesting an external transmitter to transmit the wireless signal, wherein
the noise detector detects the noise level continuously for a predetermined period of time corresponding to a period of time from when the transmitting device transmits the request signal to when the receiving device receives the wireless signal.

3. A receiver for spread spectrum communication comprising:
a receiving device configured to receive a wireless signal;
a demodulator configured to demodulate the wireless signal into a spread spectrum signal;
a correlation value calculator configured to calculate a correlation value between the spread spectrum signal and a spreading code having a first number of code portions, the spreading code having a second number of code portions in one period thereof, the second number of code portions corresponding to one bit of the spread spectrum signal;
a synchronization detector configured to detect a synchronization point between the spread spectrum signal and the spread signal having the second number of code portions based on the correlation value;
a despreading device configured to despread the spread spectrum signal based on the synchronization point;
a synchronization determination device configured to determine whether the synchronization detector succeeds in detecting the synchronization point or fails to detect the synchronization point; and
a code number setting device configured to increase the first number of code portions upon determination by the synchronization determination device that the synchronization detector fails to detect the synchronization point.
